(19) United States
(12) Patent Application Publication
(10) Pub. No.: US 2003/0178281 A1
(43) Pub. Date: Sep. 25, 2003

(54) Bill handling apparatus and method for plural currency systems or for plural accounts

(75) Inventors: Tetsuo Goto, Owariasahi (JP); Takeshi Kanagawa, Owariasahi (JP)

Correspondence Address: McDermott, Will & Emery, 600, 13th Street, N.W., Washington, DC, 20005-3096, US

(73) Assignee: Hitachi, Ltd.

(21) Appl. No.: 10/389,877

(22) Filed: Mar. 18, 2003

(30) Foreign Application Priority Data
Mar. 19, 2002 (JP) 2002-075366
Sep. 19, 2002 (JP) 2002-272430

(51) Int. Cl. G07F 7/04

(52) U.S. Cl. 194/206

(57) ABSTRACT

A bill handling apparatus or a bill handling method transacts easily with an account consisting of deposits in different currencies. The bill handling apparatus displays balances, transaction amounts and the like for a first currency and a second currency which are requested for a transaction. Alternatively, the bill handling apparatus determines a currency deposit, out of a plurality of currency deposits, corresponding to a currency input by a user and discriminated by a discriminator. Alternatively, when the user interface recognizes a request for a withdrawal transaction based on a first currency, the bill handling apparatus determines a currency deposit corresponding to the first currency out of a plurality of currency deposits that the user owns.

### BACKGROUND

The present subject matter relates to techniques and equipment for bill handling, which is provided at a financial institution or the like for processing transactions such as depositing bills in response to an operation of a user, and for handling a plurality of currency systems or for handling a plurality of accounts using such a bill handling apparatus. In the midst of the progress of internationalization of economy and industry, demands for a bill handling apparatus dealing with currencies of a plurality of monetary system are increasing. Japanese Patent Laid-open No. 17186/1989 discloses an automatic deposit and withdrawal apparatus which can deal with both yen currency and foreign currency. This automatic deposit and withdrawal apparatus only handles a transaction for one account in one currency. When a user deposits Japanese yen bills and US dollar bills, the bills are converted into one of the currencies and are added up to one account corresponding to one currency.

As a card mounting an IC chip (referred to as “IC card” hereinafter) which is capable of storing information on a plurality of accounts becomes widespread, there are more demands for a bill handling apparatus which can perform the batch transactions for a plurality of accounts. Japanese Patent Laid-open No. 139431/1994 discloses a technique to enable an inquiry regarding the balances of the plurality of accounts and to provide a list of the balances. Further, Japanese Patent Laid-open No. 99825/2000 discloses a bill handling apparatus by which a user can perform transactions with a plurality of his/her accounts by designating accounts, transaction contents, and transaction amounts of the accounts. Due to an increase in the numbers of passengers going abroad, popularization of Internet and the advent of unified currency in the European region, more users use a plural of currencies. If a user keeps an account for each currency (e.g. keeps a US dollar account separately from a Japanese yen account,), the user can convert his/her money into one currency collectively when the exchange rate between currencies is profitable for him or her. And the user can save the currency in the account and use the currency as needed. Further, there is another advantage in that the user does not have to convert money at an unprofitable exchange rate every time the user uses the money.

As mentioned above, there has been a demand for a bill handling apparatus which can readily and easily perform the transaction with an account in which currency deposits are made in respectively different currencies. However, the above-mentioned respective conventional techniques fail to take the following points into consideration.

That is, although the automatic deposit and withdrawal apparatus disclosed in Japanese Patent Laid-open No. 17186/1989 can perform the transaction in both Japanese yens and US dollars, the device fails to take the case where a user has a plurality of accounts into consideration. Further, Japanese Patent Laid-open No. 139431/1994 and Japanese Patent Laid-open No. 99825/2000 fail to consider the transaction with a plurality of accounts in which the deposits are made in respectively different currencies.

### SUMMARY

The inventive concepts alleviate the those problems with a bill handling apparatus and a method for handling a plurality of currency systems or for handling at least one account which can facilitate a transaction with at least one account in which deposits are made in different currencies.

In one aspect (1), a plurality of currencies are collectively subjected to the receiving or paying transaction with respect to a plurality of deposits in various currencies.

In the structure (1), when a user interface detects a request for a transaction in a first currency and a second currency, a controller displays information regarding a first deposit corresponding to the first currency and information regarding a second deposit corresponding to the second currency on the user interface.

Further, in another aspect (2), a transaction with a plurality of deposits can be performed easily by making the input of a deposit transaction amount unnecessary or by making the selection of deposits unnecessary.

In the aspect (2) structure, deposits respectively corresponding to currencies validated by a discriminator are determined out of a plurality of deposits. Alternatively, when the user interface detects a request for withdrawal transaction in a first currency, the controller determines a deposit corresponding to the first currency from among deposits in various currencies.

Further, in still another aspect (3), the balances of deposits displayed in currencies are converted into a currency designated by the user and are displayed in the designated currencies. Consequently, a sum of balances of respective currency deposits can be easily informed.

The structure (3) includes a display which displays a plurality of balances respectively in different currencies The structure further includes an input device enabling a user to input an instruction for converting the balances in plural currencies into one of the currencies.

Here, “account” means a separately recorded arrangement in which a customer keeps an amount of funds in a financial institution, for example, for depositing funds, withdrawing funds and filling balances for the subscriber in the financial institution. In FIG. 10, assuming 10041 as accounts, each account includes at least one currency deposit 10042. “Currency” means a money standard unit or type of national money country system, such as yen, dollar, yuan and euro or the like. “Currency” deposit means a deposit in one type of currency or an on-account deposit maintained in one type of currency or a storage field for the balance of the deposit. Additional objects, advantages and novel features of the examples will be set forth in part in the description which follows, and in part will become apparent to those skilled in the art upon examination of the following and the accompanying drawings or may be learned by production or operation of the examples. The objects and advantages of the inventive concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an appearance view of an ATM, as an example of a bill handling apparatus.

FIG. 2 is a block diagram of the ATM.

FIG. 3 is a block diagram of a financial institution center which manages multi-national-currencies.

FIG. 4 is a flowchart showing a procedure for selecting a transaction type.

FIG. 5 is a flowchart showing a procedure for a deposit transaction and examples of screens therefor.

FIG. 6 is a flowchart showing a procedure for a withdrawal transaction and examples of screens therefor.

FIG. 7 is a flowchart showing procedure for shortage covering withdrawal transaction and examples of screens therefore.

FIG. 8 is a flowchart showing a procedure for a balance inquiry transaction and examples of screens therefore.

FIG. 9 is a block diagram of a financial institution center which manages a single currency account.

FIG. 10 is a schematic view showing the relationship between accounts and currency deposits.

### DETAILED DESCRIPTION OF THE EXAMPLES

Reference now is made in detail to the examples illustrated in the accompanying drawings and discussed below. The example will be described hereinafter assuming transactions bills using in different currencies and also assuming an ATM (Automatic Teller Machine) as an example of a bill handling apparatus. Further, the ATM includes a cash dispenser which only deals with paying of money or the like. The other examples of the bill handling apparatus are a bill handling module under a teller desk, or a vending machine. Further, the bills include coins and money notes in addition to paper bills. Electronic money can apply to the described examples, except that bills cannot be actually taken out or sent out in the electronic money. Furthermore, a banking system on the Internet in addition to the ATM can apply the described examples.

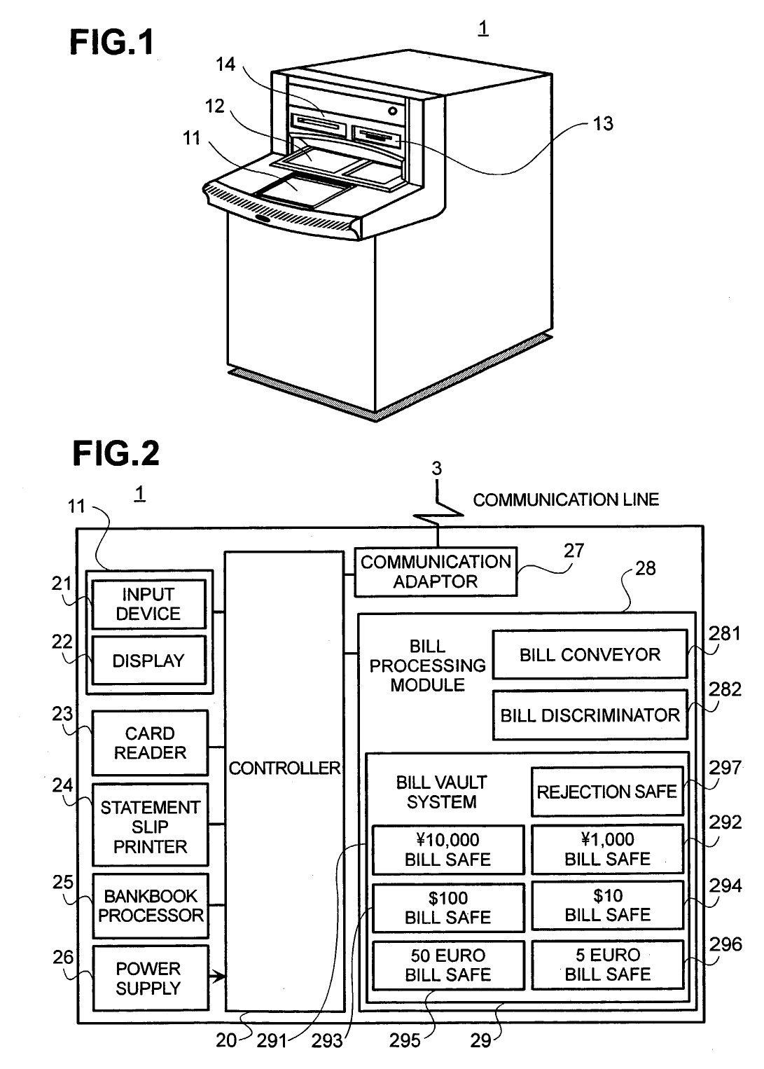

FIG. 1 is an appearance view of an ATM 1. The front face of the ATM 1 comprises an input-display device which is used both as an input device and a display (being referred to as “user interface 11”). The front of the ATM 1 also includes a deposit and withdrawal opening 12, a card insertion opening 13 and a bankbook insertion opening 14. The deposit and withdrawal opening 12 may include such a bill deposit opening and a withdrawal opening that are formed separately. In the same manner, the card insertion opening 13 and the bankbook insertion opening 14 may each comprise a discharging opening formed separately from an inserting opening.

In one example, a touch panel is used as the input device of the user interface 11. The touch panel receives an operation input from the user or a touch (contact or approach) as a signal. The display of the user interface 11 displays guidance screens for the user. Typically, the touch panel is overlaid on the face of the display 22. The display 22 guides the inputting operation of the user to the input device 21 and displays various kinds of screens. The display 22 is such as a CRT (Cathode-Ray Tube), a LCD (Liquid Crystal Display) or the like.

The deposit and withdrawal opening 12 is served for taking the bill into the apparatus and discharging them out from the apparatus. The card insertion opening 13 is for inserting a card into the apparatus. The bankbook insertion opening 14 serves for inserting a bankbook into the apparatus and for discharging the bankbook from the apparatus.

FIG. 2 is a block diagram showing a functional structure of the ATM 1 shown in FIG. 1. The user interface 11 includes the input device 21 (e.g. a touch panel or a keyboard or at least one button) and the display 22.

Further, the ATM 1 includes a card reader 23, a slip printer 24, a bankbook processor 25, a power supply 26, a communication adaptor 27 such as a LAN card or a modem, a bill processing module 28 and a controller 20. The card reader 23 reads out contents of a magnetic stripe of a magnetic card or an IC chip of an IC card which is inserted through the card insertion opening 13. The slip printer 24 prints a content of at least one transaction on a paper receipt (slip) for the statement slip and issues the statement slip. The bank book processor 25 prints the bankbook inserted through the bankbook insertion opening 14. The bankbook processor 25 also has a page turner to turn a page of the bankbook when the page to print becomes full of printing.

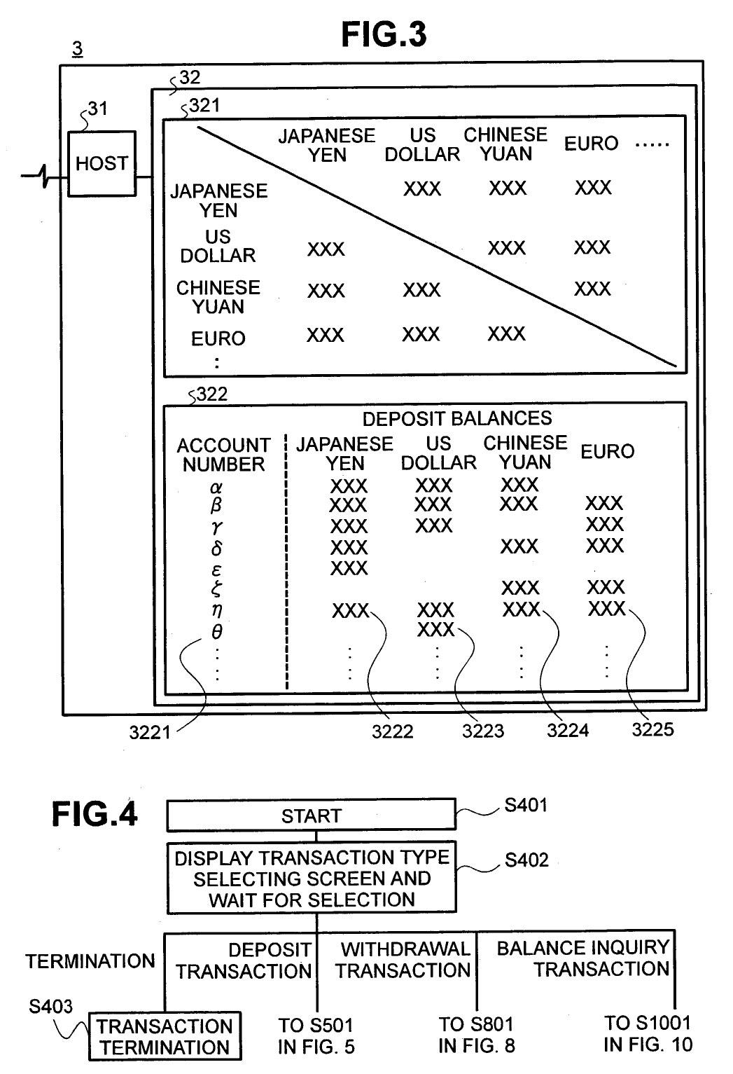

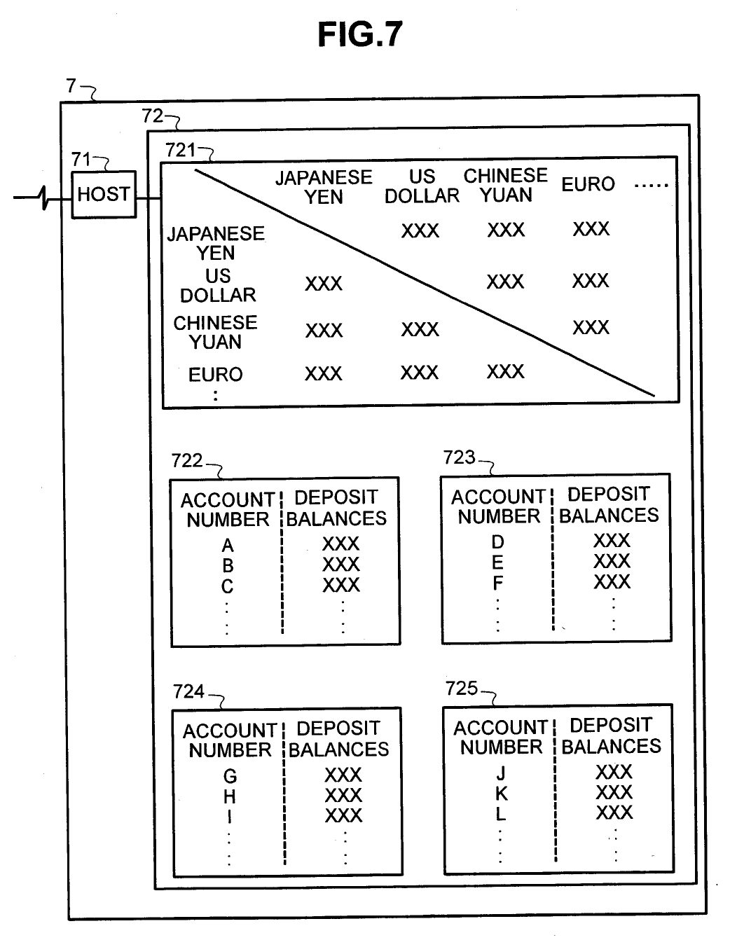

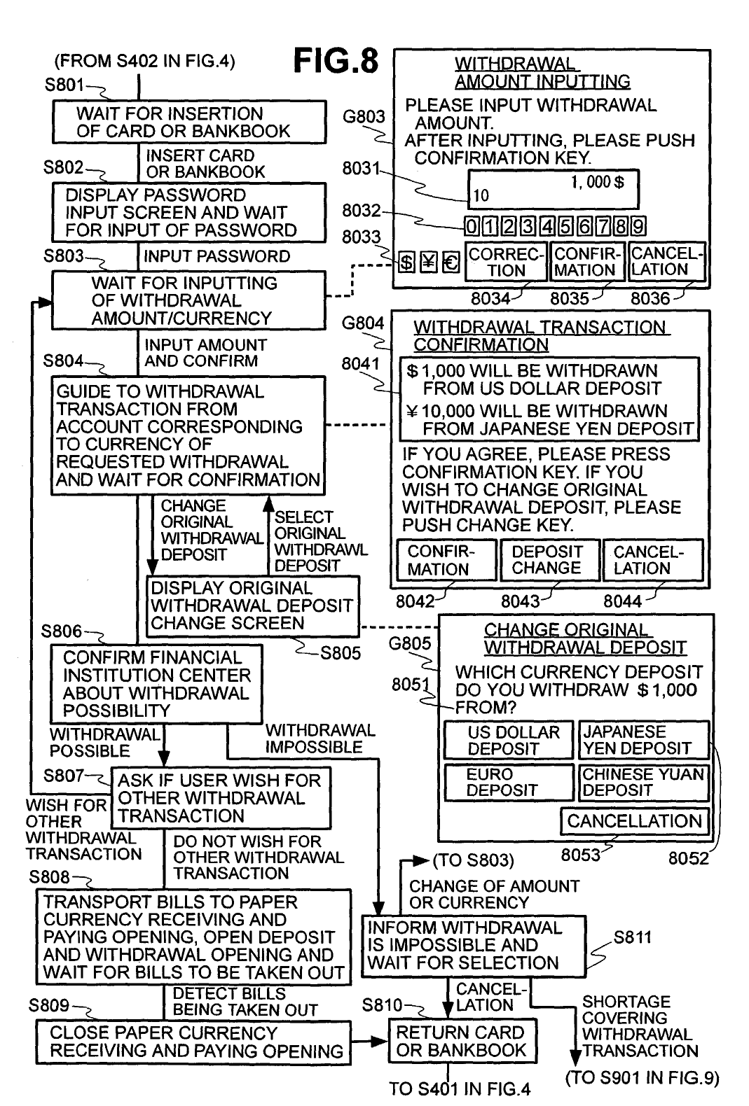

The power supply 26 supplies electricity to respective parts within the ATM 1. The communication adaptor 27 communicates with the financial institution center 3 (in FIG. 3) or 7 (in FIG. 7) through a communication line. The bill processing module 28 connects with the deposit and withdrawal opening 12 and processes the bill inserted or the bill to be discharged. The bill processing module 28 includes a bill conveyor 281 which transports the bill. The bill processing module 28 also includes a bill discriminator 282 which discriminates or validates the authenticity of the bill in various types of currencies and discriminates the currency type of a bill.

The module 28 also includes and a bill vault system 29 which stores bills.The bill vault system 29 includes a ¥10,000 bill safe 291, a ¥1,000 bill safe 292, a $100 bill safe 293, a $10 bill safe 294, a 50 Euro bill safe 295, a 5 Euro bill safe 296 and a rejection safe 297. The bill safes 291 to 296 are provided for securely storing bills of respective currencies. For example, the ¥10,000 bill safe 291 stores ¥10,000 bills in Japanese yen. In the same manner, the $100 bill safe 293 stores $100 bills in US dollar. The 50 Euro bill safe 295 stores 50 Euro bills in Euro.

The rejection safe 297 stores bills of currencies which the ATM 1 is supposed to handle but for which individual safes are not provided (such as a ¥5,000 bill or an Italian lira bill in this example). The rejection safe 297 also stores a bill which the ATM 1 is permitted to receive but is not permitted to pay by the bill discriminator 282 (such as a bill which is authorized but is judged as unsuitable to dispense because the bill is damaged or smeared).

The controller 20 controls these respective elements of the ATM 1. Further, the controller 20 is embodied by a storage device which stores control programs, a processor which executes the control programs, and a memory in which the processor executes the programs.

FIG. 3 is a block diagram showing a structure of the financial institution center 3. The financial institution center 3 has a host 31 and a file system 32. The host 31 is embodied by a main frame or at least one server. This host 31 connects with the ATM 1 by way of a communication line and an account-system computer (not shown) which manages transactions processed in the ATM 1.

The file system 32 stores information on transactions. The file system 32 is realized by a computer system which is independent from a host 31 such as a file server. In accordance with retrieval and updating instructions from the host 31, the file system 32 retrieves and updates information regarding the transactions.

Information about transactions in the file system 32 includes an exchange rate table 321 and a multi-national-currency account file 322. The exchange rate table 321 stores information on exchange rates between respective currencies. When the exchange rate changes, the host 31 updates the information for that exchange rate in the table 321. The host 31 obtains this information on the exchange rate dedicated to a foreign exchange from a host not shown in the drawing.

The multi-national-currency account file 322 manages respective balances corresponding to respective account numbers (in FIG. 3, α, β, γ . . . ) in such a manner that the balance of an account is divided among respective currencies. To be more specific, there are a Japanese yen deposit balance 3222, a US dollar deposit balance 3223, a Chinese yuan deposit balance 3224 and a Euro deposit balance 3225 in this example. These balances are made to correspond to one account number and are deposited in respective currencies. A password is registered for each account number and is authenticated by the host 31. Further, in this example, a user can select currency deposits to be opened. In FIG. 3, unopened columns of the currency deposits are left blank.

Here, an account having deposits in a plurality of types of currency under one account number is called “multi-national-currency account”. Further, each balance per currency in the multi-national-currency account, such as the Japanese yen deposit balance 3222 or the US dollar deposit balance 3223 is referred to as “a currency deposit”. Name of each currency deposit is described in such a manner that the Japanese yen deposit balance 3222 is described as “the Japanese yen deposit” and the US dollar deposit balance 3223 is described as “the US dollar deposit”.

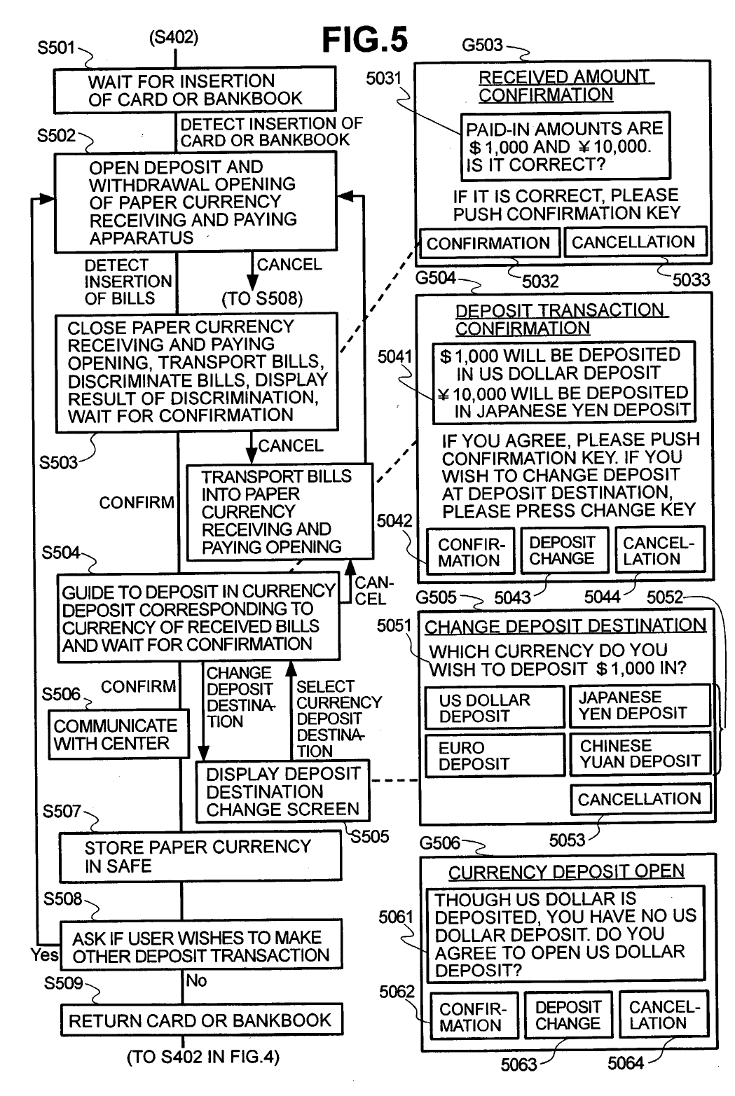

FIG. 4 to FIG. 7 are flowcharts showing control procedures executed by the controller 20 in response to the transaction of a user who possesses the account number α. The control procedures executed by the controller 20 are described in accordance with respective flowcharts hereinafter.

FIG. 4 is a flowchart showing one example of the transaction item selection processing procedure executed by the controller 20 in the ATM 1. Firstly, the controller 20 instructs the display 22 to show a screen which includes options of transaction types (deposit, withdrawal, balance inquiry and so on) on the display 22 (the user interface 11) and waits for the selection by the user (S402).

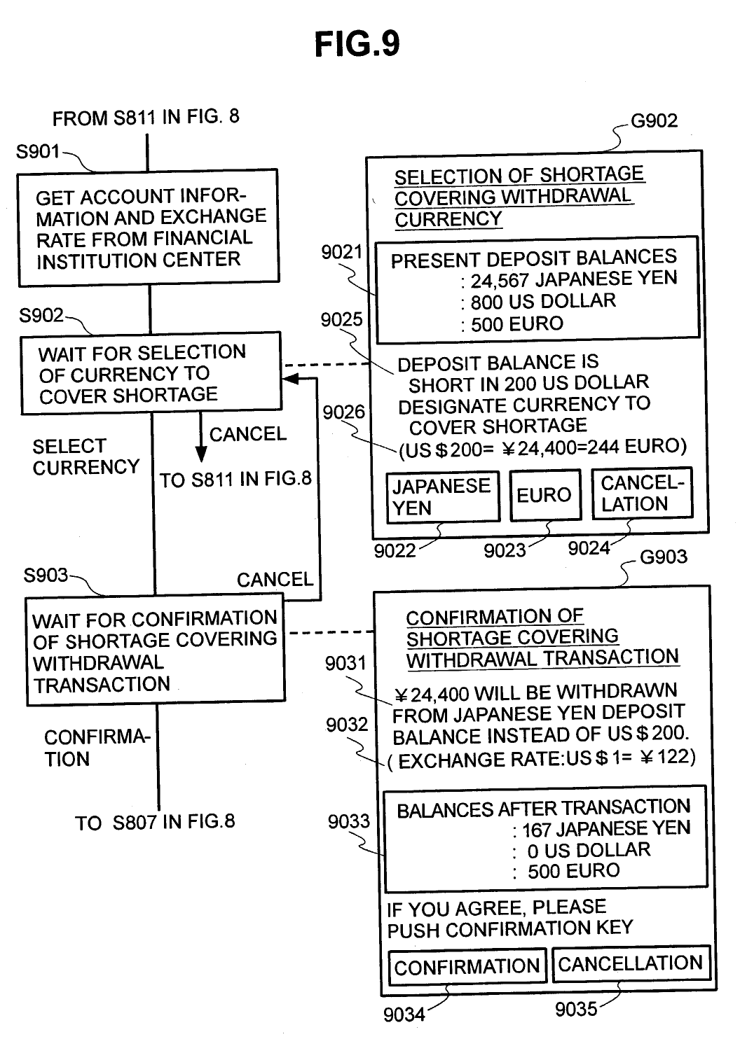

When the controller 20 detects the selection of the deposit transaction (also referred to as “receiving transaction”), the procedure proceeds to step S501 in FIG. 5. When the controller 20 detects the selection of the withdrawal transaction (also referred to as “paying transaction”), the procedure proceeds to step S801 in FIG. 8. When the controller 20 detects the selection of the balance inquiry transaction (also referred to as “balance display”), the procedure proceeds to step S1001 in FIG. 10. Further, when the user selects the termination, the procedure is terminated (S403) and returns to step S401 after a given time lapses.

1. Deposit Transaction

FIG. 5 is a flowchart showing one example of processing procedure of executing the deposit transaction at the ATM 1.

Instep S402, when the controller 20 detects the selection of the deposit transaction, the controller 20 makes the user interface 11 to display a guidance screen for insertion of a card or a bankbook. The controller 20 waits for the insertion of a card or a bankbook which realizes a storage medium (S501).

Here, the case is explained assuming that the card is inserted as the storage medium. After the controller 20 detects the insertion of the card, the card reader 23 reads out one account number stored in the card. The controller 20 connects the communication adaptor 27 with the host 31 (FIG. 3) through the communication line. Due to such a connection, the controller 20 obtains information on the existing currency deposits from the multi-national-currency account file 322.

The controller 20 obtains information from the communication adaptor 27 that there exist the Japanese yen deposit, the US dollar deposit, the Chinese yuan deposit and the Euro deposit in the account. Depending on the transacting account, there may be a case that unopened currency deposits exist. In such a case, with respect to the unopened currency deposits, the controller 20 obtains information that the currency deposits are not opened.

The controller 20 sets flags to the opened currency deposits in accordance with these information. For these flags, a register within a processor (a part of the controller 20) may be used or registers may be provided separately from the processor. When the account having the account number “β” is transacted, four currency deposit flags are set. When the account having the account number “δ” is transacted, the controller 20 sets the Japanese yen deposit flag, the Chinese yuan deposit flag and the Euro deposit flag.

Further, when the card stores information on respective opened currency deposits preliminarily, it is unnecessary to connect the controller 20 with the host 31. In such a case, the controller 20 stores the flags stored in the card. It is possible to shorten the procedure of deposit transaction by executing a processing which is performed by the bill processing module during this procedure. This processing will be described later.

The controller 20 opens the deposit and withdrawal opening 12 in order to receive the bill and wait for insertion of the bill (S502). On detection of the insertion of the bill into the deposit and withdrawal opening 12, the controller 20 closes the deposit and withdrawal-opening 12 and a bill conveyor 281 transports the bill to a bill discriminator 282. After the bill discriminator 282 validates the bill, the display 22 shows the amounts of the authorized bill out of the inserted bills in a row on user interface 11 and waits for the confirmation by the user (S503).

G503 indicates an example of a received amount confirmation screen. In one example, the user puts ten US$100 bills and ten ¥1,000 bills into the deposit and withdrawal opening 12. Hence, the screen G503 is the confirmation screen of the received amount of US$1,000 and ¥10,000 (5031). When the user judges that the displayed amounts are correct, the user selects a confirmation key 5032. While when the user judges that the displayed amounts are not correct, the user selects a cancellation key 5033. When the controller 20 detects the confirmation of the displayed amounts, the controller 20 detects a request for deposit transactions in accordance with the currencies of respective amounts (also referred to as “requested transaction” hereinafter).

The next method shows how the controller 20 checks the user's records whether the user has existing currency deposits in the same currencies as the user confirmed the requested transaction in for the newly paid-in funds.

The controller 20 detects the currencies of the requested transaction based on the selection of confirmation key 5032 and sets flags to respective recognized currencies. In setting these flags, it is also possible to use registers within the controller 20 or to use registers which are provided separately from the processor. For example, since the currency of the paid-in $1,000 amount is US dollars, a US dollar receiving flag is stored. In the same manner, the Japanese yen receiving flag is stored with respect to ¥10,000.

Next, the controller 20 compares the currency deposit flags and the bill receiving flags and judges whether the combinations of the same currencies exist or not. With respect to information of the currency deposits under the account number “β”, the controller 20 stores the Japanese yen deposit flag, the Chinese yuan deposit flag and the Euro deposit flag. Therefore, the US dollar deposit flag corresponds to the US dollar receiving flag and the Japanese yen deposit flag corresponds to the Japanese yen receiving flag.

Based on the result of this comparison, the controller 20 judges that there exist currency deposits which have the same currencies as those of the requested transaction. Further, it may be possible to retrieve the currency deposit flags using the currencies of the receiving flags as keys as to obtain the corresponding currency deposits.

When there exist currency deposits in the same currencies as those of the requested transaction, the controller 20 selects the existing deposits to perform the transaction. In accordance with this selection, the display 22 shows the guidance with respect to the selected currency deposits corresponding to the currencies of the requested transaction (e.g. bill receiving request). An example of the guidance screen is shown on G504.

G504 is an example of the guidance screen of deposit transaction confirmation. When the account number is “β”, the display 22 shows information on the currency deposit corresponding to US$1,000, the name of the current deposit “US dollar deposit” and the guidance of the deposit transaction to such a currency deposit. The display 22 also shows information on the currency deposit corresponding to the Japanese 10,000 yen, the name of the currency deposit “Japanese yen deposit” and the guidance to deposit transaction to such a currency deposit (5041).

Although the description above mentioned is the case that a plurality of currencies are received, there can be a casein which the ATM 1 receives a single currency (e.g. only the Japanese yen) out of the plurality of currency deposits possessed by the user. In this case, “Japanese yen deposit” is retrieved automatically (in the same manner as above) and the controller 20 judges the Japanese yen deposit to perform transaction.

When the user's account number is “δ”, the user possesses three kinds of currency deposits consisting of “Japanese yen deposit”, “Chinese yuan deposit” and “Euro deposit”. On the other hand, when the received bills are “Japanese yen” and “US dollar”, “Japanese Yen deposit” is automatically determined based on the Japanese Yen deposit flag. But “US dollar deposit” corresponding to “US dollar” cannot be determined. In such a case, the controller 20 informs the user that there is no currency deposited in the same currency as that of the received bills (e.g. “No US dollar deposit”) with the display 22. Then the controller 20 instructs the display 22 to show the exchange rate table 321. The display 22 also shows information on the currency deposits with which the deposit transaction is capable so as to enable the user to select the accessible currency deposit.

When there is no currency deposit in the same currency as those of the requested transaction in this manner, there may be another processing. Besides the processing of S 505, the accessible currency deposit may be automatically determined within the ATM 1. That is, the controller 20 preliminarily stores which type of currency deposit is to be selected out of plural types of currency deposits as information on the order of priority. Then, the controller 20 determines the currency deposit corresponding to a requested transaction based on the priority information.

With regard to this order of priority, the controller 20 selects the currency deposit of the country where the ATM 1 is installed. When such a country is Japan, a first priority is set to the Japanese yen because the amount of Japanese yen in circulation is large and the demand for Japanese yen is generally large. Further, by inquiring into the user's history of transaction, the priority order in selecting the currency deposits may be set to the order of frequency of transaction by the particular customers. When the user preliminarily registers the order of priority, the controller 20 may determine the currency deposits in accordance with such an order of priority.

The display 22 displays information on the currency deposit determined in accordance with the steps as illustrated on G504. For example, the display 22 shows the names and the balances of the determined currency deposits. Or the display 22 shows the deposit transaction to the determined deposit currencies. The display 22 also shows the message for confirmation (S504).

Further, the controller 20 may execute a processing to open a corresponding new currency deposit instead of the processing in which the paid-in funds are converted into other currency units. In such a case, the display 22 shows the guidance for confirmation of opening a currency deposit shown on G506. With respect to this case where the account number is “δ” although US dollars are received, no US dollar deposit exists. Accordingly, the controller 20 asks the user to confirm whether the user wishes to open a US dollar deposit or not via the display 22.

When the controller 20 detects pushing of the confirmation key, the controller 20 informs the host at the center 3 side of the user's intention to open the US dollar deposit through the communication adaptor 27. Further, this screen 506 may also include a currency changing key 5063. With this key 5063, the user can select the change from one currency deposit to another currency deposit without opening the currency deposit.

Although the display 22 shows the guidance screen for currency deposit opening confirmation as a single screen G506, the display 22 may show the guidance screen combined with the guidance screen G504. There may be an existing currency deposit corresponding to only a part of the received currencies. In that case, the display 22 shows the guidance of confirmation of deposit transaction and the guidance of confirmation of opening a new currency deposit for the non-existing new other of the received currencies on one screen. The guidance screen may include confirmation keys to the respective message of guidance separately or one confirmation key may have a function of confirming two message of guidance.

As described above, in the deposit transaction procedure or in the bill handling apparatus adopting such procedure, the user firstly pays and the user interface 11 guides the currency deposit corresponding to the received bill. In this way, the user can execute the deposit transaction with the currency deposit as the user wishes by selecting the confirmation key. Accordingly, the procedure can be simplified. The convenience for users is enhanced, and the operational efficiency of the ATM can be enhanced. Furthermore, even when there is no existing currency deposit corresponding to the received currency, the display 22 shows the guidance screen of opening a new currency deposit corresponding to the received currency. Hence, the transaction procedure can be simplified.

Next description is concerning the processing of the ATM when the user wishes to make a deposit transaction in one currency with the resulting deposit credited in another currency. In preparation for such a case, the screen G504 provides the currency changing key 5043. The currency changing key 5043 is a means for changing the predetermined currency deposit to another currency deposit.

When the controller 20 detects the selection of the currency changing key 5043, the controller 20 retrieves possible currency deposits for deposit transaction from the financial institute center 3. Using the account number “β” as the key, the controller 20 stores four types of currency deposit flag: the Japanese yen deposit flag, the US dollar deposit flag, the Chinese yuan deposit flag and the Euro deposit flag. ATM 1 can handle these four currencies in the transaction. Accordingly, the user interface 11 displays the deposit changing screen for changing the currency as shown on G505 (S505).

G505 displays a received amount 5051, at least one option key 5052, and a cancellation key 5053. The option key 5052 indicates the names of the currency deposits whose flag is stored. A cancellation key 5053 enables canceling of the change of currency. When the controller 20 detects pushing of one of the selection keys 5052, the procedure returns to step S504 to guide the deposit transaction with the selected currency deposit. When the user wishes to deposit US$1,000 in the Euro deposit, the user pushes the “Euro deposit” key. Then, in addition to the deposit transaction of ¥10,000 in the Japanese yen deposit, the display 22 shows a converted amount in the Euro from US$1,000 by using the exchange rate. The display 22 also shows the guidance to the deposit transaction from the converted amount into the Euro deposit. The exchange rate used for the conversion is a rate obtained from the exchange rate table 321 and a handling fee may be added to the exchange rate. Referring the exchange rates at sides of the respective option keys 5052 on G505 helps the user to select the currency deposits.

In S504, when the controller 20 detects the confirmation of the displayed deposit transaction, the controller 20 instructs the communication adaptor 27 to connect with the financial institution center 3. Then, the host 31 adds the amount of the confirmed deposit transaction to the confirmed currency deposit in the multi-national-currency deposit account file 322 (S506). When the controller 20 detects the confirmation of the deposit transaction displayed on G504 with respect to the account number β. The host 31 adds ¥10,000 to the balance “xxx” of the Japanese yen deposit of the account number β and US$1,000 to the balance “xxx” of the US dollar deposit. At this time, the currency of the received bills (e.g. US dollar) can be different from the currency (e.g. Euro) of the currency deposit. In this case, the amount of the latter currency deposit is converted using the exchange rate stored in the exchange rate table 321. The host 31 adds converted amount to the corresponding former currency deposit.

On the other hand, the bill conveyor 281 transports the received bills of respective currencies from the deposit and withdrawal opening 12 to the corresponding safe (291, 292, 293 and so on) among the bill safes 29. The bills are stored in the appropriate safe(S507). Then, the controller 20 terminates a series of operations of the deposit transaction.

Here, the controller 20 asks the user whether the user wishes to perform other deposit transaction or not (S508). When the user wishes to perform an other deposit transaction, the controller returns the procedure to step S502 and accepts the next deposit transaction. When the user has no wish for another deposit transaction, the controller 20 returns the card. The controller 20 instructs the slip printer 24 to issue a statement slip with the contents of the transaction. Alternatively, the controller 20 instructs the bankbook processor 25 to print the contents of the transaction on the inserted bankbook and return the bankbook (S509).

In the description above, the controller 20 judges the presence or the absence of the currency deposit having the same currency as that of the received and confirmed amount. The controller 20 determines the currency deposit as the currency deposit corresponding to the confirmed currency. With respect to another example, the bill handling apparatus may be configured such that the host 31 in the financial institution center 3 performs the procedures of the controller 20. That is, the host 31 receives the currency of the confirmed currency (the received currency flag) and the account number and checks the file system 32 using the account number.

In such a case, the host 31 obtains the currency deposit corresponding to the account number from the file system 32 and stores the currency deposit flag in itself. There also exists a processing as followed. The host 31 compares this currency deposit flag and the received currency flag obtained through communication, and selects the corresponding currency deposit. Then the host 31 transmits information on the selected currency deposit to the controller 20 through the communication adaptor 27. And the controller 20 sets the received information into a memory therein.

In this processing, the host 21 executes comparison. The ATM 1 receives the result of the comparison and determines the currency deposit corresponding to the received bills. The structure of this example can reduce a load incurred by the processing of the controller 20. The structure can also suppress the amount of information which passes through the communication line. The same goes for the explanation of the flow chart shown in FIG. 8 and like in this respect.

In the explanation of FIG. 5, the controller 20 executes the cancellation of the transaction upon the user's selection of a “cancellation” key 5033 in the display screen on G503 or the like. Also the same goes for the explanation of the flow chart shown in FIG. 8 and like in this respect.

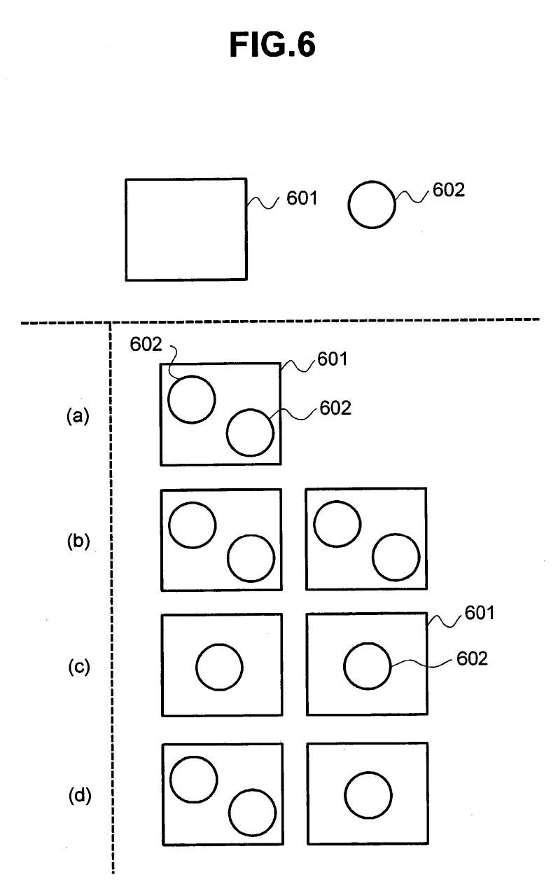

Next explanation is focusing on the financial institution center 3 side connected to the ATM 1 in conjunction with FIG. 6 and FIG. 7. The financial institution center 3 is configured such that the user possesses one account and a plurality of currency deposits based on various types on national currencies are controlled in this account. Therefore, the descriptions are concerned the case in which the ATM 1 reads only one account number. However, even when the user possesses a plurality of accounts, the ATM can execute the similar processing.

FIG. 6 schematically shows the relationship between an account 601 and currency deposits 602 stored in the account 601. In the multi-national-currency example, one account 601 stores a plurality of currency deposits 602 as shown in line (a) of FIG. 6. When the user possesses a plurality of accounts as in the case line (b) of FIG. 6, the ATM 1 can handle bill in the same manner as the case shown in line (a) of FIG. 6. In the case line (b), the ATM 1 reads out the user's account numbers “α” and “β” stored in storage medium shown in FIG. 3. The ATM 1 executes respective transactions with respective accounts separately such as the Japanese yen deposit for α and the US dollar deposit for β.

Line (c) of FIG. 6 shows a case where one account 601 stores one currency deposit 602. This is the case of a single currency account in contrast with the multi-national-currency account like line (a) and (b) of FIG. 6. Further the currency deposits is possible in the case of line (d) of FIG. 6. Line (d) of FIG. 6 is the mixing state of the multi-national-currency account and the single currency account. The same goes for the explanation of the flow charts shown in FIG. 8 and ensuing drawings with respect to these points.

Another example is possible for a case in which the same financial institution center controls the single currency account and the multi-national-currency account. Alternatively, it is possible for a case in which the respective financial institution centers control a plurality of currency accounts separately.

FIG. 7 is a block diagram showing a financial institution center 7 which manages the single currency account shown in FIG. 6, line (c). The difference of this financial institution center 7 and 3 shown in FIG. 3 lies in that each account number corresponds to one currency. That is, a file system 72 in FIG. 7 includes a Japanese yen account file 722, a US dollar account file 723, a Chinese yuan account file 724 and a Euro account file 725. Each account file manages the balance corresponding to each respective currency. Further, in the same manner as the file system 32 in FIG. 3, the file system 72 has an exchange rate table 721 and the passwords corresponding to respective accounts.

2. Withdrawal Transaction

FIG. 8 is a flowchart showing one example of processing procedure of the withdrawal transaction executed by the controller 20 of the ATM 1. When the controller 20 detects the selection of the withdrawal transaction in step S402, the controller 20 displays a guidance screen for insertion of a card or a bankbook on the user interface 11. The controller 20 waits for the insertion of a storage medium by the user(S801). Hereinafter, the explanation is about the procedure assuming that the card is inserted.

When the user inserts the card, the card reader 23 reads information stored in the card, especially an account number. In the same manner as the deposit transaction, the controller 20 obtains information on the currency deposit. Further, the controller 20 guides the user to input the password into the user interface 11 and waits for the inputting of the password (S802).

When the user inputs the password with the user interface 11, the controller 20 instructs the display 22 to show a screen asking the user to input and to confirm the withdrawal amount on the user interface 11. G803 is an example of the prompt screen. The controller 20 waits for the inputting and the confirmation by the user (S803).

G803 comprises an input area 8031, numeral keys 8032, currency selection keys 8033, a correction key 8034, a confirmation key 8035 and a cancellation key 8036. The input area 8031 is an area for inputting the requested withdrawal amount. The numeral keys 8032 are keys which the user uses for inputting the desired amount in the input area. The currency selection keys 8033 are keys which enable the selection of currencies. The possible currencies are the Japanese yen, the US dollar and the Euro which the ATM 1 stores to dispense in withdrawal transactions. The correction key 8034 is a key to be pushed when the correction of inputting is necessary. The confirmation key 8035 is a key which the user pushes when the controller 20 detects the confirmation of the withdrawal of the amount inputted in the input area. The cancellation key 8036 is a key which the user pushes when the user wants to cancel the transaction.

When the user wishes for the withdrawal transaction of US $1,000, the user can request the withdrawal amount of US $1,000 by following procedures. The user pushes the numeral keys 1, 0, 0, 0 sequentially and the key $ out of the currency keys, confirms the displayed amount, and pushes lastly the confirmation key. When the user requests for the withdrawal amounts in a plurality of currencies, it is unnecessary to perform the withdrawal transaction every currency one by one separately. Here, the explanation is assuming that the user requests a withdrawal in Japanese yen and US dollar.

When the user confirms the requested withdrawal amount, in the same manner as the above-mentioned deposit transaction, the controller 20 determines the currency deposit corresponding to the requested currency for the withdrawal. Then, the controller 20 instructs the display 22 to show information on the determined currency deposit and ask for the confirmation by the user (S804).

G804 is a guidance screen to confirm the withdrawal transaction when the user requests the withdrawal of US$1,000 from the US dollar deposit. G804 displays a column 8041 which guides the withdrawal transaction of ¥10,000 from the Japanese yen deposit. G 804 also displays a confirmation key 8042. The user selects the confirmation key 8042 when he/she agrees with the withdrawal transaction and a cancellation key 8044. G804 further displays a currency changing key 8043. The currency changing key 8043 is the key for changing the original withdrawal deposit. When the controller 20 detects the selection of the currency changing key 8043, the display 22 shows a screen which changes the original withdrawal deposit (S805). G805 is an example of the screen. The currency changing key 8043 helps the user to select the withdrawal transaction from any arbitrary currency deposit thus offering options to the user.

G805 comprises a withdrawal designated amount 8051, at least one option key for the original withdrawal deposit 8052 and a cancellation key 8053. The option key 8053 is the key to select an original withdrawal deposit such as Japanese yen deposit key, US dollar deposit key or the key for other account. When the controller 20 detects the selection of one of the option keys 8052, the procedure returns to step S804 and the controller 20 guides the user through the withdrawal transaction from the selected currency deposit. The cancellation key 8053 is the key to cancel the change of the original withdrawal deposit.

When the user selects the confirmation key for the withdrawal transaction in step S804, the controller 20 communicates with the host 31 in the financial institution center 3 via the communication adaptor 27. The content of the communication is the transmission of the account number, the password, the currency deposit for withdrawal and the requested withdrawal amount. Furthermore, the controller 20 asks the host 31 whether the requested withdrawal transaction is possible or not and waits for a reply (S806).

The host 31 in the financial institution center 3 receives the inquiry from the controller 20 and collates the password. When the password is authentic, the host 31 retrieves the multi-national-currency account file 322 by using the account number as a key. After retrieval, the host 31 checks the currency deposits. When an amount in each currency requested for the withdrawal is less than the balance of each currency deposit confirmed as the existing amount already on deposit, and when there is no other restriction, the host 31 transmits a message that the withdrawal is possible to the ATM 1. When a requested withdrawal amount in each currency exceeds the balance of each currency deposit or when there exist some restrictions, the host 31 transmits a message that the withdrawal is impossible to the ATM 1.

When the withdrawal of the requested amount is possible, the controller 20 further asks the user whether the user wishes for another withdrawal via the display 22 (S807). When the user wishes for another withdrawal transaction, the procedure returns to step S803 and accepts a new request for withdrawal transaction.

In this manner, the ATM 1 determines and displays the currency deposit corresponding to that requested for withdrawal. Hence, the user can obviate time and efforts in selecting the currency deposit before inputting the requested withdrawal amount and inputting the transaction amount. Accordingly, the convenience increases and the simplified procedure can enhance the operational efficiency of the apparatus.

In the example above, the ATM 1 requests the user to input the password before inputting the requested withdrawal amount. Instead, the ATM 1 may request the user to input the password after the user confirms the transaction with the guidance of the currency deposit corresponding to the requested withdrawal amount. In this case, assuming that the storage medium on the card stores the account numbers α and β and only the account numbers a relates to the currency deposit for the withdrawal transaction, it is enough to input only the password for α. The operation becomes less complicated without the unnecessary inputting and hence, the convenience increases.

When the user does not wish to execute another withdrawal transaction in step S807, the controller 20 instructs the bill processing module 28 to discharge the requested amounts of bills from bill safes (US dollar safe and Japanese yen safe in this example) corresponding to the currencies to be withdrawn out of the bill storage safe 29. The bill conveyor 281 transports the discharged bills to the deposit and withdrawal opening 12. When the requested amounts of bills reach the deposit and withdrawal opening 12, the deposit and withdrawal opening 12 opens and the controller 20 waits for the user to take out the bill (S808).

When the user takes the bill from the deposit and withdrawal opening 12, the controller 20 instructs the deposit and withdrawal opening 12 to close (S809). Then, the controller 20 instructs the card reader 23 to return the card. The controller 20 also instructs the statement slip printer 24 to print and output a statement slip. Alternatively, the controller 20 instructs the bankbook processor to print and return the bankbook. The controller 20 communicates with the financial institution center 3 via the communication adaptor 27 about the withdrawal transaction. And the host 31 deduces the amount of the withdrawal transaction from the corresponding currency deposit in the multi-national-currency account file 322 and the procedure returns to step S401.

When the withdrawal is impossible in step S806, the controller 20 instructs the display 22 to show a message relating to the situation. This message invites an operation to change the requested amount or the currency, or an operation to cancel the transaction (S811).

Here, there is an option in which the controller 20 executes the withdrawal transaction by covering the shortage of one deposit from another deposit without changing the requested amount and the currency. By choosing this option, the user can withdraw the balance in the selected account and then the required amount can be withdrawn by a series of operations. This option reduces burden of the user to terminate one transaction and to repeat another transaction.

Further, there may be another option when the balance of the currency deposit in the inputted currency is less than the required withdrawal amount. It may be possible to select the withdrawal transaction of an amount as much as the balance of the requested currency deposit. Alternatively, it may be also possible to leave the specific currency deposit intentionally by designating another currency deposit. That is, when the user wishes to leave the peculiar currency deposit, he/she can select another currency deposit at his/her convenience. Due to such a structure, a handling fee at next exchange is no more necessary. In the case where the user is going to use and leave US$1,000 in US dollar, he/she can avoid a drawback of unwished withdrawal from the US dollar deposit to cover the short balance of the requested another currency deposit.

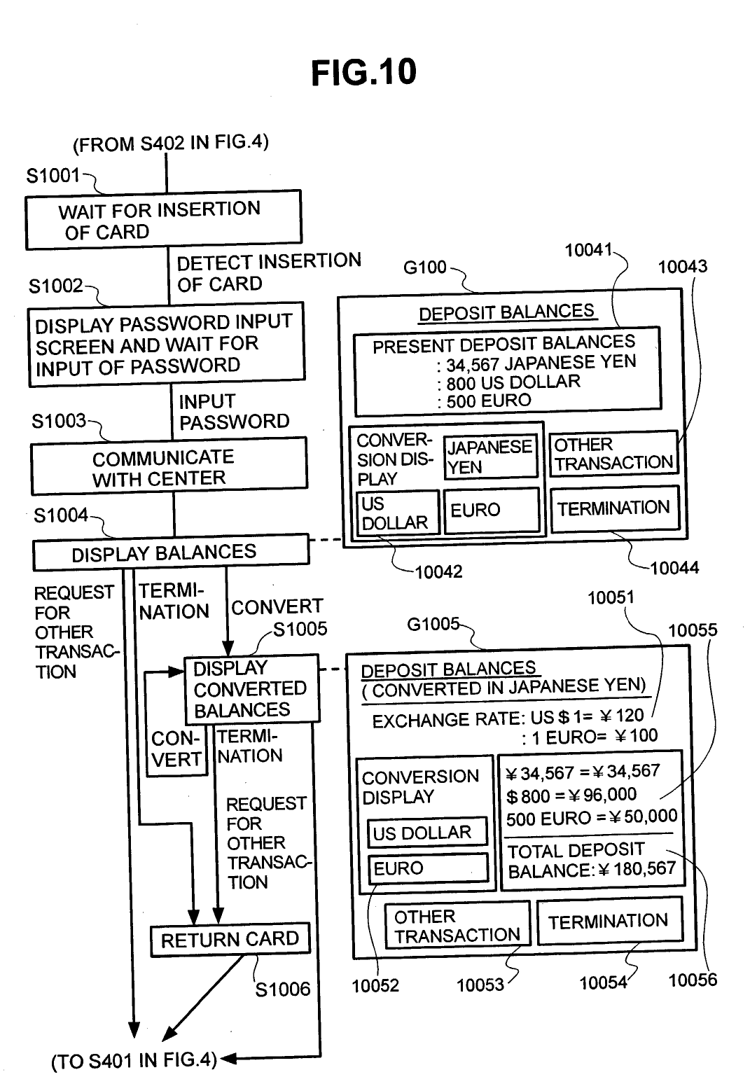

FIG. 9 is a flowchart showing an example of the processing procedure when the controller 20 detects the covering shortage withdrawal transaction in step S811.

Firstly, the controller 20 obtains information on the account and the exchange rate from the file system 32 in the financial institution center 3 via the communication adaptor 27. Then, the controller 20 instructs the display 22 to show a screen (G902) with the following information: the balances of a plurality of currency deposits, amounts short with respect to the withdrawal request and the converted balances as subjects of the shortage covering withdrawal transaction in the requested currency. The screen also asks the user to select the currency deposit for coverage of the shortage (S902).

G902 is an example of a screen in the case where there are ¥24,567 in Japanese yen (balance after the requested withdrawal amount of ¥10,000 is deducted), $800 in US dollar and 500 Euro in Euro in the balance deposits for the user's account and he/she requests US$1,000 as a withdrawal amount. US$200 is short ($1,000-$800=$200) to execute the requested withdrawal transaction (9025). Therefore, the screen invites the user to change the currency in order to cover the shortage by selecting the Japanese yen key 9022 or the Euro key 9023.

Further, it is facilitating for the user to select the currency with the amount ($200) in short together with an amount converted into the currency in which the withdrawal is possible to cover the shortage ($200=¥24,400=244 Euro) (9026). Here, it is further preferable to display the exchange rate which is used for the conversion because the user can feel reassured. Although not shown in this example, exchange rates for other currencies may also be displayed, for example, to allow a customer to select a cover currency with the most favorable exchange rate.

The user pushes the Japanese yen key 9022 to select Japanese yen as the currency to be exchanged. The user pushes the Euro key 9023 to select Euro. This example describes the case where the user selects Japanese yen.

When the controller 20 detects pushing of Japanese yen key 9022 to cover the shortage, the controller 20 instructs the display 22 to show a screen G903. G903 indicates the deducting amount from the Japanese yen deposit and the balance of the Japanese yen deposit after the withdrawal. G903 also asks the user for his/her confirmation (S903).

G903 displays a message that ¥24,400 converted into Japanese yen ($200×¥122/$1=¥24,400) (9031) will be deducted from the balance of Japanese yen deposit. G903 shows also the balance ¥167 of Japanese yen deposit after the deduction (¥24,567−¥24,400=¥167) (9033) and an exchange rate used for the conversion 9032. The user pushes a confirmation key 9034 upon confirming the displayed content of the transaction. Instead of step S902, the user or the financial institution center 3 may predetermine the currency or the order of priority of currencies to be selected for the shortage covering withdrawal transaction before the transaction starts. For example, the order of priority of the currencies for withdrawal to cover the shortage can be determined in the order of the Japanese yen, the US dollar and the Euro at the ATM 1 or at the financial institution center 3. In this case, the controller 20 may perform the entire control such that the procedure advances to step S903 by skipping S902. Since the number of transaction steps can be cut down, it is advantageous for the user and the financial institution.

Besides, it may be possible to refer the balances of the respective currency deposits as information on the currency deposits from the host 31 for determining currency deposits corresponding to the requested withdrawal amounts. Such a structure makes it possible to guide only the currency deposits which have enough balances for the requested withdrawal amounts.

3. Balance Inquiry

FIG. 10 is a flowchart showing one example of processing in which the controller 20 of the ATM 1 executes the balance inquiry.

When the controller 20 detects the selection of balance inquiry at S402, the controller 20 instructs the display 22 to show a screen for card insertion and waits for the insertion of the card (S1001). When the user inserts the card into the ATM 1, the card reader 23 reads out information stored in the card. The card reader 23 reads out at least the ID number such as the account number.

The screen guides the user to input a password on the user interface 11 and waits for inputting of the password (S1002). When the card stores a plurality of account numbers, the controller 20 may invite the user to input a plurality of passwords. Alternatively the controller 20 may invite the user to select accounts and input only the passwords for the selected accounts.

When the user inputs the password, the controller 20 instructs the communication adaptor 27 to connect with the host 31 and waits for the reply (S1003). The host 31 collates the password(s) and retrieves the multi-national-currency deposit account file 322 using the account number as a key. The host 31 transmits the balances of the respective currency deposits of the account corresponding to the password to the ATM 1.

When the ATM 1 receives the reply, the controller 20 instructs the display 22 to show a screen comprising balances in respective currencies. G1004 is an example of the screen (S1004). G1004 includes a list of balances of respective currency deposits (10041). This display list enables the user to check the balances of respective currency deposits in respective currencies at a glance.

G1004 also includes at least one conversion display key 10042 (displayed as keys such as a Japanese yen key or a US dollar key). This is the key for designation of currencies and for conversion of the currencies of the balances into the selected currency. The user pushes the key 10042 in order to display respective balances in a form that the currencies of these balances are converted in one currency. The conversion display key 10042 enhances the convenience for the user.

When the controller detects the touching of one of the conversion display keys 10042 in step S1004, the controller 20 connects with the host 31 via the communication adaptor 27. The controller obtains the exchange rate stored in the exchange rate table 321 and converts the respective balances using the obtained exchange rate. The display 22 shows the converted results as shown in G1005 as an example (S1005).

Moreover, it is possible that the host 31 converts the balances of the respective currency deposits instead of the ATM 1 and transmits the conversion results to the ATM 1. For example, in step S1083, after collating the password, the host 31 executes the conversion using information on the balances of the respective currency deposits of the account in the file system 32 corresponding to the password and the exchange rate table 321. After the conversion, the host 31 transmits the converted balances to the ATM 1 instead of transmitting the balances of the respective currency deposits in the corresponding account. The controller 20 receives the conversion results via the communication adaptor 27. The display 22 shows the results in the same manner. This structure reduces the processing performed by the controller 20.

G1005 is an example of the displayed conversion results of the respective balances (S10055). Further, the display 22 can show a sum of the conversion results in addition to the conversion results of respective balances (S10056). This enables for the user to grasp the total amount of the respective balances more easily. Furthermore, the display 22 shows the exchange rates 10051 and the currency changing key. The user can use the exchange rates for confirmation. The user can use the currency designation keys for displaying such that the balances are further converted into another currency (such as the US dollar key and the Euro key) 10052.

When the controller 20 detects the selection of the currencies for conversion in step S1005, the controller 22 converts the balances of the deposits in a plurality of currencies into the selected currency.

The exchange rate (122 ¥/$) on G902 and on G903 is larger than the exchange rate (120 ¥/$) shown as an example on G1005. The difference is attributed to whether a handling fee is included or not. When the bills are actually converted to be deposited or be withdrawn, the financial institution shows the exchange rate including the handling fee in order to charge the handling fee. The ATM 1 converts the amounts on the basis of such an exchange rate. When the balances are converted just for display, the display 22 shows the exchange rate excluding a handling fee for the user. Also, the conversion is processed with such an exchange rate to allow the user to grasp the current prices of his/her balances as accurate as possible. Further, the display 22 may show the unified exchange rate to avoid the confusion of the user.

When the controller 20 detects the selection of the transaction termination key 10044 or 10054 in step S1005 or S1006, the controller 20 instructs the card reader 24 to return the card and terminates the transaction (S1006). Further, a key to execute another transaction (other transaction key 10043 or 10053) enables the user to continue another transaction such as the depositing or the withdrawal, after the user checks his/her balances. When the controller 20 detects the selection of the key 10043 or 10053, the procedure returns to step S401 and the controller performs the selection of transaction types.

Further, the ATM 1 reads out the account number on the card to inquire or collate the balances and displays the balances on the display 22. This procedure can be replaced with using a reader of a PC (Personal Computer) or a mobile terminal account number. Alternatively, the user can input the account number and the PC or the mobile terminal displays the balance.

According to the disclosures, the transactions can be performed easily with a plurality of currency deposits and the convenience of the bill handling apparatus can be enhanced.

While the foregoing has described what are considered to be the best mode and/or other examples, it is understood that various modifications may be made therein and that the invention or inventions disclosed herein may be implemented in various forms and examples, and that they may be applied in numerous applications, only some of which have been described herein. It is intended by the following claims to claim any and all modifications and variations that fall within the true scope of the inventive concepts.

What is claimed is:

1. A bill handling apparatus comprising:
a controller which detects a request for a transaction in a first currency and a second currency,
and a user interface which displays information about a possible transaction on a first currency deposit corresponding to the first currency and on a second currency deposit corresponding to the second currency.

2. A bill handling apparatus according to claim 1, wherein
the user interface displays requested contents of the transaction in the first currency and the second currency and a confirmation key of the transaction,
the controller detects the selection of the confirmation key as the request for the transaction in the first currency and the second currency.

3. A bill handling apparatus according to claim 1, wherein
the first currency deposit is maintained in the first currency, and the content of the second currency deposit is maintained in the second currency.

4. A bill handling apparatus according to claim 1, wherein
the first currency deposit is a first balance included in an account of a financial institution, and
the second currency deposit is a second balance included in the account of the financial institution.

5. A bill handling apparatus comprising:
an opening for taking in a bill,
a discriminator for judging a currency type of the bill taken in by the opening,
a controller for determining a currency deposit which corresponds to the currency type of the bill judged by the discriminator out of a plurality of currency deposits owned by a user and,
a display for displaying information about the first currency deposit.

6. A bill handling apparatus according to claim 5, further comprising
a reader for reading an account number from a storage medium, and wherein
the plurality of the currency deposits correspond to the account number and are maintained in the plurality of currency types respectively,
the controller sets flags about the plurality of the currency types and determines whether each of the plurality of currency types of the flags coincides with the currency type of the bill judged by the discriminator.

7. A bill handling apparatus according to claim 5, further comprising
on the plurality of the currency deposits from the a communication adaptor for communicating with a host connected through a communication line, the communication adaptor receiving information host, and wherein
the plurality of the currency deposits correspond an account number and
the controller determines the currency deposit based on the information acquired from the communication adaptor.

8. A bill handling apparatus according to claim 5, wherein
the display further displays a key for changing the currency deposit determines by the controller into one of the second currency deposits.

9. A bill handling apparatus according to claim 5, wherein
the controller compares the currency type of the bill judged by the discriminator and respective currency types of the plurality of the currency deposits and determines the currency deposit which coincides with one of the currency types of the plurality of the currency deposits.

10. A bill handling apparatus according to claim 5, wherein
each of the currency deposits is a balance which is maintained in one type of currency included in a single account of a financial institution.

11. A bill handling apparatus comprising:
a user-interface for receiving a request of withdrawal transaction and for outputting information based on the request; and
a controller which, when the user interface receives the request for withdrawal transaction in a currency, determines a currency deposit corresponding to the user's requested currency from a plurality of currency user's deposits in a respective plurality of currencies.

12. A bill handling apparatus according to claim 11, further comprising
a communication adaptor for communicating with a host through a communication line and wherein
the controller determines the currency deposit which corresponds to the requested currency based on information obtained from the host.

13. A bill handling apparatus according to claim 11, wherein
each of the currency deposits is a balance which is deposited in one type of currency included in a single account of a financial institution.

14. A bill handling apparatus comprising:
a display for displaying balances of plural deposits which are deposited in currencies different from each other and;
an input device enabling a user to input an instruction request for a conversion of at least one of the balances of the plural deposits into a selected one of the currencies.

15. A bill handling method comprising the steps of:
receiving a request for a transaction in a plurality of currencies,
determining currency deposits to be transacted corresponding to respective requested currencies; and
providing a guide information for a transaction with respect to the determined currency deposits.

16. A bill handling method in a financial institution center comprising the steps of:
receiving an account number and information of at least one requested currency;
retrieving and storing information of currency deposits in at least one currency corresponding to the account number;
comparing whether the currency corresponding to the account number coincides to the requested currency; and
outputting information on each of the currency deposits of which currency coincides to the requested currency.

17. A bill handling method in a financial institution comprising the steps of:
receiving a single account number;
retrieving and storing balances of a plurality of currency deposits in a plurality of currency corresponding to the account number;
receiving an information of a selected currency to be converted into;
converting the stored balances of the currency deposits in the currencies into the selected currency based upon exchange rates; and
outputting the converted balances in the selected currency.

18. An automatic withdrawal handling apparatus comprising:
an input device which receives a request of withdrawing transaction, a first currency of withdrawing bills, and a withdrawing amount in the currency of the withdrawing bills;
a controller which confirms a balance of a first currency deposit based on the inputted first currency; and
a display displaying a selection screen which enables a user to select at least one second withdrawing currency for shortage covering when the balance of the first currency deposit is short to cover the withdrawing.

19. An automatic handling apparatus according to claim 18, wherein
the selection screen includes balance information of existing currency deposits in the selection screen.

20. An automatic handling apparatus according to claim 18, wherein
the selection screen includes exchange rates for the first currency and for the second currency.

21. An automatic handling apparatus according to claim 18, wherein
the display further displays a plural number of currencies to be selected for shortage covering in the selection screen.
